(19) United States
(12) Patent Application Publication
(10) Pub. No.: US 2023/0364924 A1
(43) Pub. Date: Nov. 16, 2023

(54) Voice Controlled Label Printer Device

(71) Applicant: Dana James Malley, Farmington, NY (US)

(72) Inventor: Dana James Malley, Farmington, NY (US)

(21) Appl. No.: 17/743,594

(22) Filed: May 13, 2022

(51) Int. Cl. B41J 3/407; G10L 15/22; B41J 3/36

(52) U.S. Cl. CPC B41J 3/4075; G10L 15/22; B41J 3/36; G10L 2015/223

(57) ABSTRACT

A voice controlled label printer device for labeling refrigerated food items by voice command includes a housing having a back wall and a front wall. Additionally, the housing has a plurality of side walls. The housing has an interior and an outlet. A microprocessor is positioned in the interior of the housing. The microprocessor has a microphone and a speaker, and the microprocessor renders information provided into the microphone and executes functions within the housing. A printer is positioned on the first side wall within the interior of the housing. The printer prints a current date and the food name. A spool is positioned within the interior of the housing and has a roll of labels enwrapped around the spool. The spool provides the labels for the printer. A battery is in electric communication with the microprocessor and provides electric power to the microprocessor.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to date label printer devices and more particularly pertains to a new date label printer device for labeling refrigerated food items by voice command.

### (2) Description of Related Art Including Information Disclosed Under 37 CFR 1.97 and 1.98

The prior art relates to date label printer devices. The prior art relates to a variety of label printer devices configured for labeling refrigerated food with the date and time. Known prior art lacks a date label printer device configured for labeling refrigerated food by voice command activation.

### BRIEF SUMMARY OF THE INVENTION

An embodiment of the disclosure meets the needs presented above by generally comprising a housing having a back wall and a front wall. Additionally, the housing has a plurality of side walls. The housing has an interior and an outlet. The outlet is positioned on a first side wall of the plurality of side walls. A microprocessor is positioned in the interior of the housing. The microprocessor has a microphone and a speaker, and the microprocessor is configured for rendering information provided into the microphone and executing functions within the housing. A printer is positioned on the first side wall within the interior of the housing. The printer is configured for printing a current date and the food name. A spool is positioned within the interior of the housing and has a roll of labels enwrapped around the spool. The spool is configured for providing the labels for the printer. A battery is in electric communication with the microprocessor and is configured for providing electric power to the microprocessor.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a voice controlled label printer device according to an embodiment of the disclosure.

FIG. 2 is a front view of an embodiment of the disclosure.

FIG. 3 is a cross-sectional view of an embodiment of the disclosure taken from FIG. 1 of Line 3-3.

FIG. 4 is a flow diagram view of an embodiment of the disclosure.

FIG. 5 is a block diagram view of an embodiment of the disclosure.

FIG. 6 is a front view of an embodiment of the disclosure.

FIG. 7 is a back view of an embodiment of the disclosure.

FIG. 8 is an in-use view of an embodiment of the disclosure.

### DETAILED DESCRIPTION OF THE INVENTION

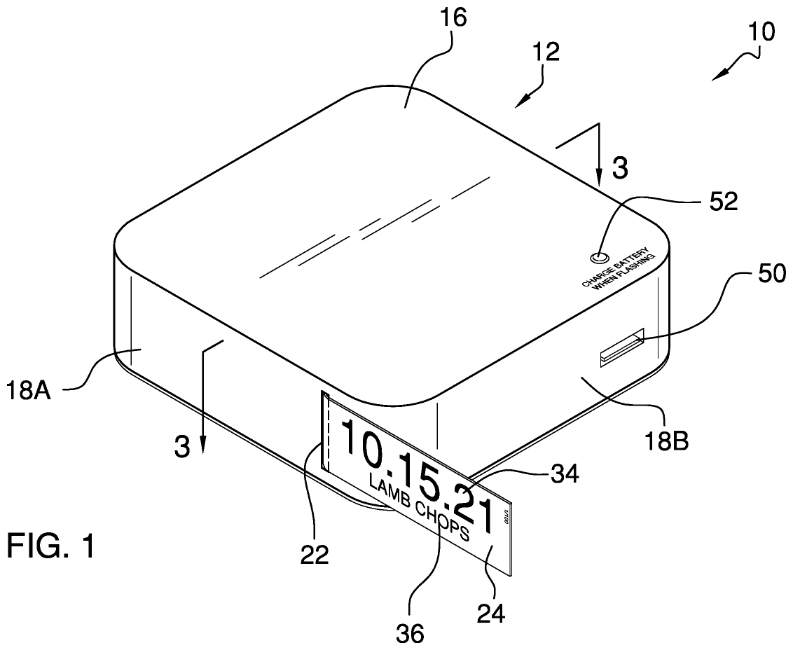

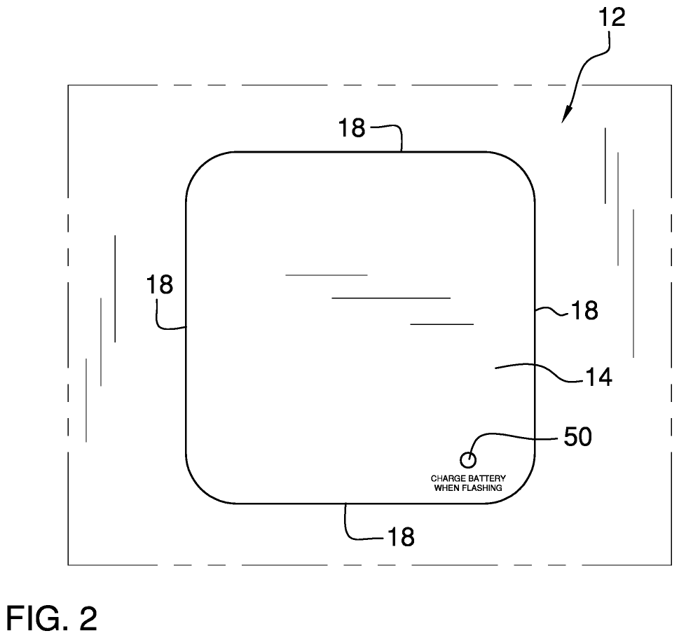

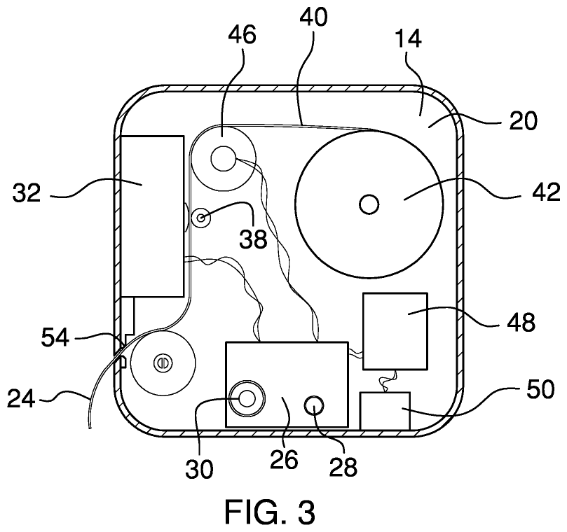

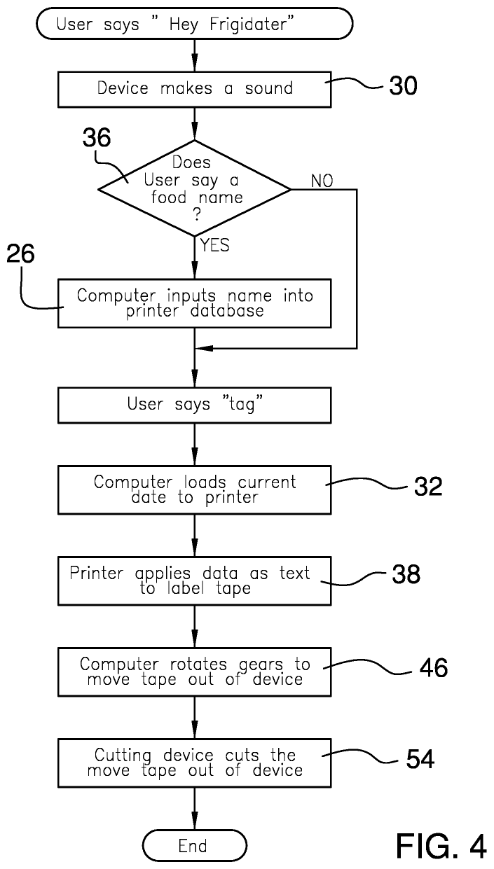

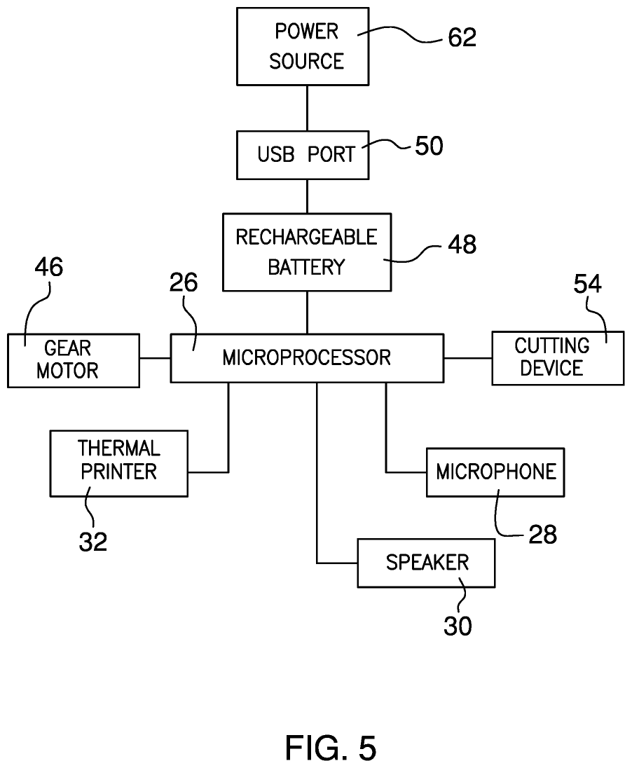

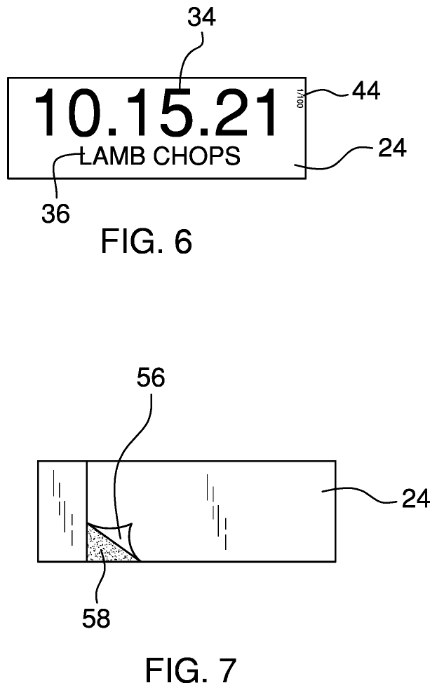

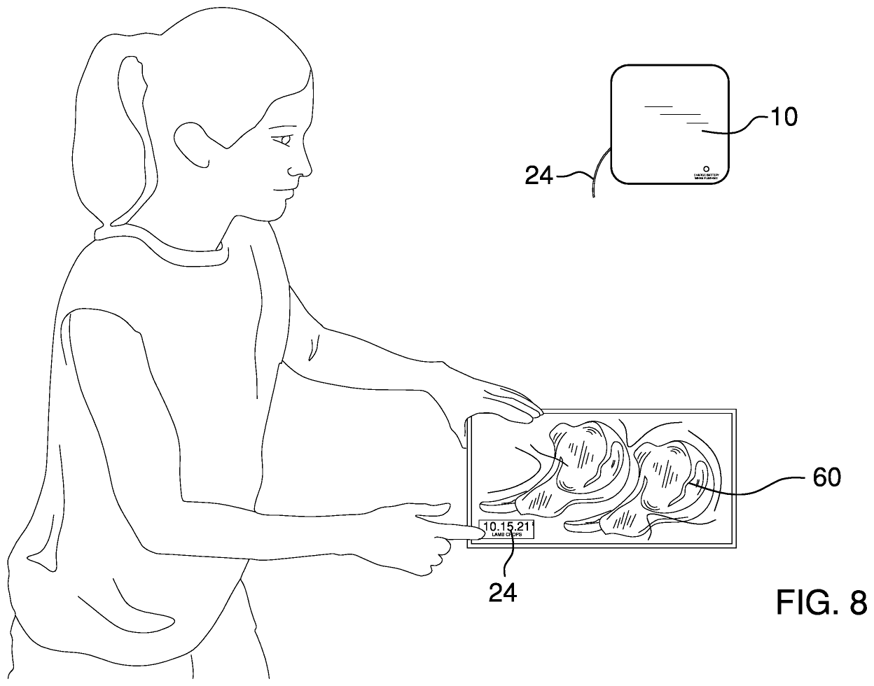

With reference now to the drawings, and in particular to FIGS. 1 through 8 thereof, a new date label printer device embodying the principles and concepts of an embodiment of the disclosure and generally designated by the reference numeral 10 will be described.

As best illustrated in FIGS. 1 through 8, the voice controlled label printer device 10 generally comprises a housing 12 having a back wall 14 and a front wall 16. The back wall 14 and the front wall 16 are parallel relative to each other. Furthermore, the housing 12 has a plurality of side walls 18 being positioned from the back wall 14 to the front wall 16. Each of the side walls 18 is positioned perpendicular relative to the back wall 14 and the front wall 16. Furthermore, the housing 12 has an interior 20 defining a space for a variety of elements to be positioned within. The housing 12 has an outlet 22 positioned on a first side wall 18A of the plurality of side walls 18. The outlet 22 is an aperture where a new label 24 is dispensed from.

A microprocessor 26 is positioned in the interior 20 of the housing 12. The microprocessor 26 has a microphone 28 and a speaker 30, wherein the microprocessor 26 is configured for rendering information provided into the microphone 28 and executing functions within the interior 20 of the housing 12. The microphone 28 is configured for recording a food name said by the user, and for recording a command to print a new label 24. The speaker 30 is configured for emitting a noise to signal recording of the microphone 28. The microprocessor 26 is a voice activated processor that actuates when the phrase, “Hey Frigidater” is spoken.

A printer 32 is positioned on the first side wall 18A within the interior 20 of the housing 12. The printer 32 is in electric communication with the microprocessor 26, wherein the microprocessor 26 sends information to the printer 32 to be printed onto the new label 24. The printer 32 is configured for printing a current date 34 and the food name 36 on the new label 24. The printer 32 has a head 38 being configured for applying the characters of the current date 34 and the food name 36 to the new label 24. The head 38 of the printer 32 is the ink cartridge that physically engages with the new label 24.

A roll of labels 40 is enwrapped around a spool 42. The spool 42 is positioned within the interior 20 of the housing 12 and is configured for providing the labels 40 to the printer 32. The roll of labels 40 is configured to contain an amount of one hundred labels, with each of the labels 40 having a reference number 44 to signify the amount of labels 40 used within the spool 42. The spool 42 is in mechanical communication with a rotating gear 46, and the rotating gear 46 is in electric communication with the microprocessor 26. The rotating gear 46 actuates rotation when the microprocessor 26 initiates the process of printing a new label 24. The rotating gear 46 is configured for feeding the roll of labels 40 from the spool 42 to the printer 32.

A battery 48 is in electric communication with the microprocessor 26 and is configured for providing electric power to the microprocessor 26. Additionally, the battery 48 is in electric communication with a universal serial bus port 50 positioned on a second side wall 18B of the plurality of side walls 18. The second side wall 18B is positioned adjacent and perpendicular relative to the first side wall 18A. The universal serial bus port 50 is configured for providing electricity to the battery 48. The battery 48 is rechargeable and can be resupplied with electricity from a power source 62.

A light 52 is positioned on the front wall 16 of the housing 12 and is in electric communication with the battery 48. The light 52 is a light emitting diode configured for flashing when the battery 48 has a low supply of electricity. The light 52 will cease flashing when the power source 62 is inputted into the universal serial bus port 50 or when the battery 48 is resupplied with electricity.

A cutting device 54 is positioned adjacent to the outlet 22 of the first side wall 18A. The cutting device 54 is positioned within the interior 20 of the housing 12 and is in electric communication with the printer 32. The cutting device 54 is a slicer used to separate the new label 24 from the roll of labels 40 within the interior 20 of the housing 12. The new label 24 has a bisected backing 56 to be removed to reveal an adhesive surface 58. The adhesive surface 58 of the new label 24 can be fastened upon a food 60 configured to be refrigerated.

In use, the user says the phrase, “Hey Frigidater.” The speaker 30 of the microprocessor 26 emits a sound to signify the microphone 28 is now recording. The user can either say a food name 36 that will be recorded by the microprocessor 26, such as “Lamb Chops,” or the user can bypass this by saying the command, “Tag.” The microprocessor 26 loads the current date 34 and food name 38 to the printer 32, where the head 38 of the printer 32 applies the current date 34 and the food name 36 to the new label 24. Subsequently, the microprocessor 26 actuates the rotating gear 46 to feed the new label 24 through the outlet 22 of the housing 12, and the cutting device 54 engages with the new label 24 by separating the new label 24 from the roll of labels 40. The user can remove the bisecting backing 56 from the new label 24 to unveil the adhesive surface 58, wherein the adhesive surface 58 can fasten the new label 24 to the food 60.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A refrigerated food label printer device comprising:
a housing having a back wall and a front wall, said housing having a plurality of side walls, said housing having an interior, said housing having an outlet, said outlet being positioned on a first side wall of said plurality of side walls;
a microprocessor being positioned in said interior of said housing, said microprocessor having a microphone and a speaker, said microprocessor being configured for rendering information provided into said microphone and executing functions within said housing;
a printer being positioned on said first side wall within said interior of said housing, said printer being configured for printing a current date and the food name;
a spool being positioned within said interior of said housing, said spool having a roll of labels enwrapped around said spool, said spool being configured for providing said labels for said printer, said spool being extendable through said outlet, said outlet being slanted extending through first side wall wherein said labels extend outwardly from said housing defining an acute angle between said labels and said first side wall; and
a battery being in electric communication with said microprocessor, said battery being configured for providing electric power to said microprocessor.

2. The refrigerated food label printer device of claim 1, further comprising said back wall and said front wall being parallel relative to each other.

3. The refrigerated food label printer device of claim 1, further comprising each of said side walls being positioned from said back wall to said front wall, each of said side walls being positioned perpendicular relative to said back wall and said front wall.

4. The refrigerated food label printer device of claim 1, further comprising said interior defining a space for a variety of elements to be positioned within.

5. The refrigerated food label printer device of claim 1, further comprising said outlet being an aperture.

6. The refrigerated food label printer device of claim 1, further comprising said microphone being configured for recording a food name and a command to print a label, said speaker being configured for emitting a noise to signal recording of said microphone.

7. The refrigerated food label printer device of claim 1, further comprising said printer being in electric communication with said microprocessor.

8. The refrigerated food label printer device of claim 1, further comprising said printer having a head, said head of said printer being configured for applying the characters of the current date and the food name to the label.

9. The refrigerated food label printer device of claim 1, further comprising said spool being in mechanical communication with a rotating gear, said rotating gear being in electric communication with said microprocessor, said rotating gear being configured for feeding said label from said spool to said printer.

10. The refrigerated food label printer device of claim 1, further comprising said battery being in electric communication with a universal serial bus port, said universal serial bus port being positioned on a second side wall of said plurality of side walls, said universal serial bus port being configured for providing electricity to said battery, said battery being rechargeable.

11. The refrigerated food label printer device of claim 1, further comprising a cutting device being positioned adjacent to said outlet of said first side wall, said cutting device being positioned within said interior of said housing, said cutting device being in electric communication with said printer, said cutting device being configured to creating a split for a new label to be removed from the roll of labels.

12. The refrigerated food label printer device of claim 1, further comprising a light being positioned on said front wall of said housing, said light being in electric communication with said battery, said light being a light emitting diode, said light being configured for flashing when said battery having a low amount of electricity.

13. A refrigerated food label printer device comprising:
a housing having a back wall and a front wall, said back wall and said front wall being parallel relative to each other, said housing having a plurality of side walls, each of said side walls being positioned from said back wall to said front wall, each of said side walls being positioned perpendicular relative to said back wall and said front wall, said housing having an interior, said interior defining a space for a variety of elements to be positioned within, said housing having an outlet, said outlet being positioned on a first side wall of said plurality of side walls, said outlet being an aperture;
a microprocessor being positioned in said interior of said housing, said microprocessor having a microphone and a speaker, said microprocessor being configured for rendering information provided into said microphone and executing functions within said housing, said microphone being configured for recording a food name and a command to print a label, said speaker being configured for emitting a noise to signal recording of said microphone;
a printer being positioned on said first side wall within said interior of said housing, said printer being in electric communication with said microprocessor, said printer being configured for printing a current date and the food name, said printer having a head, said head of said printer being configured for applying the characters of the current date and the food name to the label;
a spool being positioned within said interior of said housing, said spool having a roll of labels enwrapped around said spool, said spool being configured for providing said labels for said printer, said spool being in mechanical communication with a rotating gear, said rotating gear being in electric communication with said microprocessor, said rotating gear being configured for feeding said label from said spool to said printer, said spool being extendable through said outlet, said outlet being slanted extending through first side wall wherein said labels extend outwardly from said housing defining an acute angle between said labels and said first side wall;
a battery being in electric communication with said microprocessor, said battery being configured for providing electric power to said microprocessor, said battery being in electric communication with a universal serial bus port, said universal serial bus port being positioned on a second side wall of said plurality of side walls, said universal serial bus port being configured for providing electricity to said battery, said battery being rechargeable;
a cutting device being positioned adjacent to said outlet of said first side wall, said cutting device being positioned within said interior of said housing, said cutting device being in electric communication with said printer, said cutting device being configured to creating a split for a new label to be removed from the roll of labels; and
a light being positioned on said front wall of said housing, said light being in electric communication with said battery, said light being a light emitting diode, said light being configured for flashing when said battery having a low amount of electricity.
